(19) United States
(12) Patent Application Publication
(10) Pub. No.: US 2014/0183394 A1
(43) Pub. Date: Jul. 3, 2014

(54) CONDUCTANCE VALVE AND VACUUM PROCESSING APPARATUS

(71) Applicant: CANON ANELVA CORPORATION, Kawasaki-shi (JP)

(72) Inventors: Satoshi YAMADA, Kawasaki-shi (JP); Ryuji Higashisaka, Kawasaki-shi (JP)

(73) Assignee: CANON ANELVA CORPORATION, Kawasaki-shi (JP)

(21) Appl. No.: 14/080,329

(22) Filed: Nov. 14, 2013

(30) Foreign Application Priority Data
Dec. 27, 2012 (JP) 2012-285352

(51) Int. Cl. F16K 1/16

(52) U.S. Cl. CPC F16K 1/16
USPC 251/228

(57) ABSTRACT

A conductance valve is configured to be able to adjust the conductance by adjusting the opening degree of an opening formed in part of the wall surface a vacuum vessel. The conductance valve includes a swing arm which is pivotally coupled to a driving portion, and a rectangular valve body which is coupled to the swing arm and is pivotal with respect to it. When the swing arm pivots, the rectangular valve body is pivoted by a predetermined angle. The overhang of the valve body at the closed position of the conductance valve can be reduced.

### BACKGROUND OF THE INVENTION

1. Field of the Invention

The present invention relates to a conductance valve and vacuum processing apparatus.

2. Description of the Related Art

A conductance valve is interposed between a chamber and a vacuum pump. The conductance valve has a function of closing the vacuum pump when the chamber is released to the atmosphere for the purpose of maintenance or the like, and also has a function of adjusting the conductance of the vacuum pump. That is, the conductance valve changes the opening degree of the valve to adjust the exhaust port area (conductance) and perform pressure control (=exhaust velocity control) in the chamber.

As conductance valves, a bridge type and pendulum type are known. The bridge valve adjusts the opening amount of the exhaust port by a valve body in accordance with a shaft which has the valve body fixed at the distal end, and extends and contracts. The pendulum valve adjusts the opening amount of the exhaust port by rotating a shaft which has a valve body fixed at the distal end, and thereby swinging the valve body (see, for example, Japanese Patent Laid-Open Nos. 2011-247426, 2010-127320, 2008-025836, 2007-271080, and 2007-170666).

The pendulum valve can easily retract the valve body from the opening range of the vacuum pump because the valve body swings. Therefore, compared to the bridge valve, the pendulum valve is capable of easy exhaustion at a maximum exhaust velocity (maximum conductance) and is often attached to a vacuum pump of a large exhaust amount.

Most pendulum valves are double or more in size than the pump opening diameter because the valve body is retracted by swing and requires a retraction space. If the valve unit is interposed between the chamber and the pump, the storage case of the valve body overhangs laterally from the chamber and may hinder improvement of the maintenance workability of the chamber.

The present invention is made to solve the above problems, and provides a space-saving conductance valve. The present invention also provides a vacuum processing apparatus with good workability by reducing the space of the conductance valve.

### SUMMARY OF THE INVENTION

The present invention can provide a space-saving conductance valve because the overhang of the storage case of the valve body of a conductance valve can be downsized. The present invention can also provide a vacuum processing apparatus with good maintenance workability by reducing the space of the conductance valve.

According to one aspect of the present invention, there is provided a conductance valve capable of adjusting a conductance by adjusting an opening degree of an opening formed in part of a vacuum vessel, comprising: a rectangular valve body; an arm configured to pivotally couple the valve body; and a driving portion configured to pivot the arm, wherein the valve body is pivoted along with pivoting of the arm, and the opening degree of the opening is adjusted in accordance with the pivoting of the valve body.

Further features of the present invention will become apparent from the following description of exemplary embodiments (with reference to the attached drawings).

### BRIEF DESCRIPTION OF THE DRAWINGS

FIG. 1 is a schematic sectional view showing a vacuum processing apparatus according to the first embodiment;

FIG. 2 is a perspective view showing a conductance valve according to the first embodiment;

FIG. 3 is an exploded perspective view showing the conductance valve according to the first embodiment;

FIG. 4 is a sectional view showing the periphery of the conductance valve;

FIG. 5 is a sectional view taken along a line A-A in FIG. 4;

FIGS. 6A to 6C are views for explaining the operation of the conductance valve according to the first embodiment;

FIGS. 7A to 7C are schematic sectional views showing the second embodiment;

FIGS. 8A to 8C are schematic sectional views showing the third embodiment;

FIGS. 9A to 9E are schematic sectional views showing the fourth embodiment; and

FIG. 10 is a schematic sectional view showing a vacuum processing apparatus according to the fifth embodiment.

### DESCRIPTION OF THE EMBODIMENTS

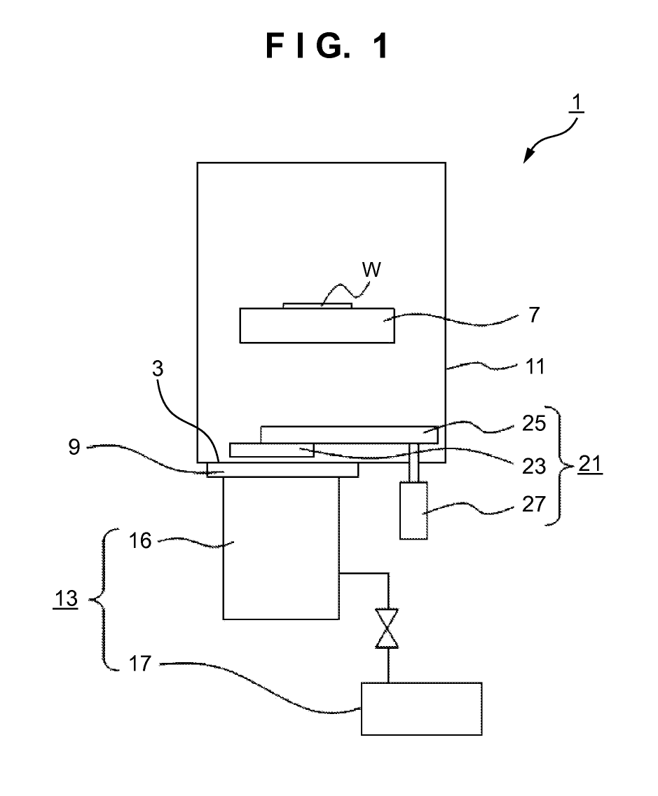

FIG. 1 is a schematic view showing a vacuum processing apparatus according to the first embodiment. A vacuum processing apparatus 1 according to the embodiment includes a vacuum vessel 11, exhaust device 13, and conductance valve 21. The vacuum vessel 11 incorporates a substrate holder 7 capable of placing a substrate W, and is configured to be able to perform predetermined vacuum processing such as deposition or annealing for a substrate. An attaching portion 9 is disposed at a bottom 3 of the vacuum vessel 11 to connect the exhaust device 13. An opening 5 is formed in the attaching portion 9 of the exhaust device 13 that is disposed on the bottom 3 of the vacuum vessel 11. As a vacuum pump, the exhaust device 13 includes, for example, a turbo-molecular pump (TMP) 16 and a dry pump 17 which reduces the back pressure of the TMP 16. The conductance valve 21 is disposed to adjust the opening degree of the opening 5 formed in part (bottom 3) of the vacuum vessel 11. As will be described later, the present invention can be practiced even if the opening 5 is formed in another member in place of the bottom 3, so a member in which the opening 5 is formed will be generically called a base.

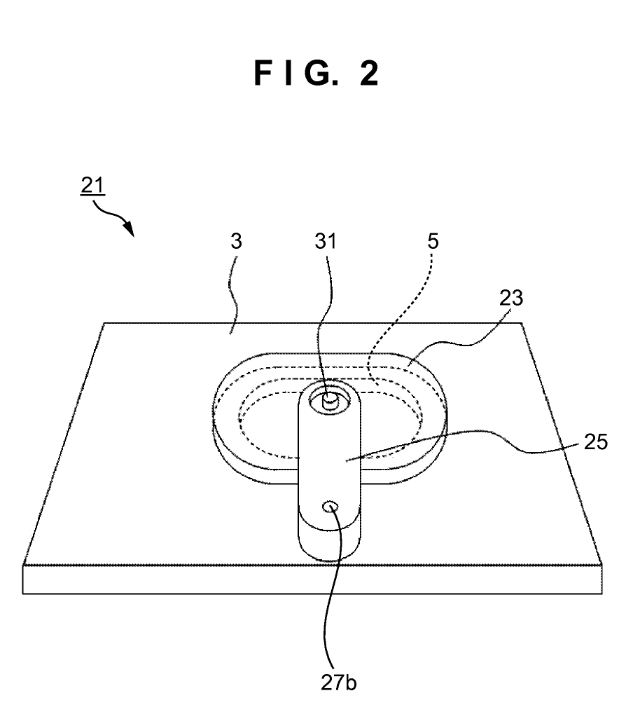

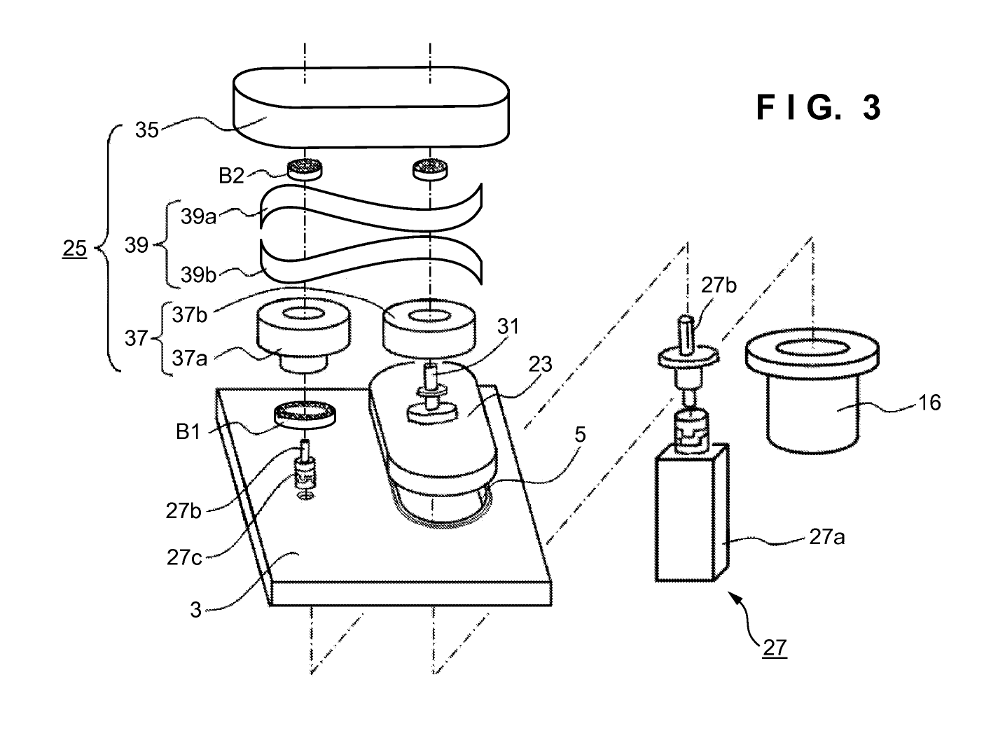

FIG. 2 is a perspective view showing the conductance valve 21. FIG. 3 is an exploded perspective view showing the conductance valve 21. FIG. 2 is a perspective view showing a state (closed position) in which the conductance valve 21 is closed. The conductance valve 21 according to the embodiment includes a valve body 23, swing arm 25, and driving portion 27. The valve body 23 is configured to be able to adjust the opening degree of the conductance valve 21 by shielding the opening 5 of the bottom 3 of the vacuum vessel 11 and changing the opening area of the shielded opening 5. The valve body 23 is pivotally coupled to the swing arm 25. The valve body 23 is a rectangular plate member made of a metal such as stainless steel, an aluminum alloy, or the like. The rectangular shape as the shape of the valve body means a shape in which the longitudinal dimension (length) and widthwise dimension (width) are different. This rectangular shape includes shapes such as a rectangular shape whose corners are rounded, like the valve body 23, and an elliptical shape. A shaft member 31 is fixed at the center position of the valve body 23.

When the vacuum vessel 11 or conductance valve 21 has a function of bringing the valve body 23 close to the opening 5, the opening 5 can be shielded (closed) by pressing the outer edge of the valve body 23 against the edge of the opening 5. In this case, an O-ring 5a is preferably attached around the opening 5 as a seal member which comes into contact with the periphery of the valve body 23 to ensure air tightness. Needless to say, an O-ring or the like may be attached as a seal member to the opening 5 of the valve body 23.

As shown in FIG. 3, the driving portion 27 includes a motor 27a and a driving shaft 27b connected to the motor 27a. The motor 27a is attached on the atmosphere side to the bottom 3 of the vacuum vessel 11. The motor 27a is, for example, a servo motor, but suffices to be a motor capable of detecting the rotation angle by an encoder. A rotation introducing portion 27c is connected to the driving shaft 27b, and one end of the driving shaft 27b is introduced into the vacuum vessel 11. In the embodiment, the motor 27a is disposed on the atmosphere side, and the output shaft of the motor 27a and the driving shaft 27b are connected on the atmosphere side. One end of the driving shaft 27b is introduced into the vacuum vessel 11 while the rotation introducing portion 27c keeps the inside of the vacuum vessel 11 airtight. When, for example, a direct drive motor (DD motor) is used as the motor 27a, the rotation introducing portion 27c can be omitted because the output shaft of the DD motor can be arranged on the vacuum side.

The motor-side driving shaft 27b and the valve body-side shaft member 31 are coupled to the two ends of the swing arm 25. The swing arm 25 can be moved while the valve body 23 is rotated in accordance with the rotation angle of the driving shaft 27b. That is, the valve body 23 can move to rotate with respect to the swing arm 25, and adjust the opening degree (opening area) of the opening 5 of the vacuum vessel 11.

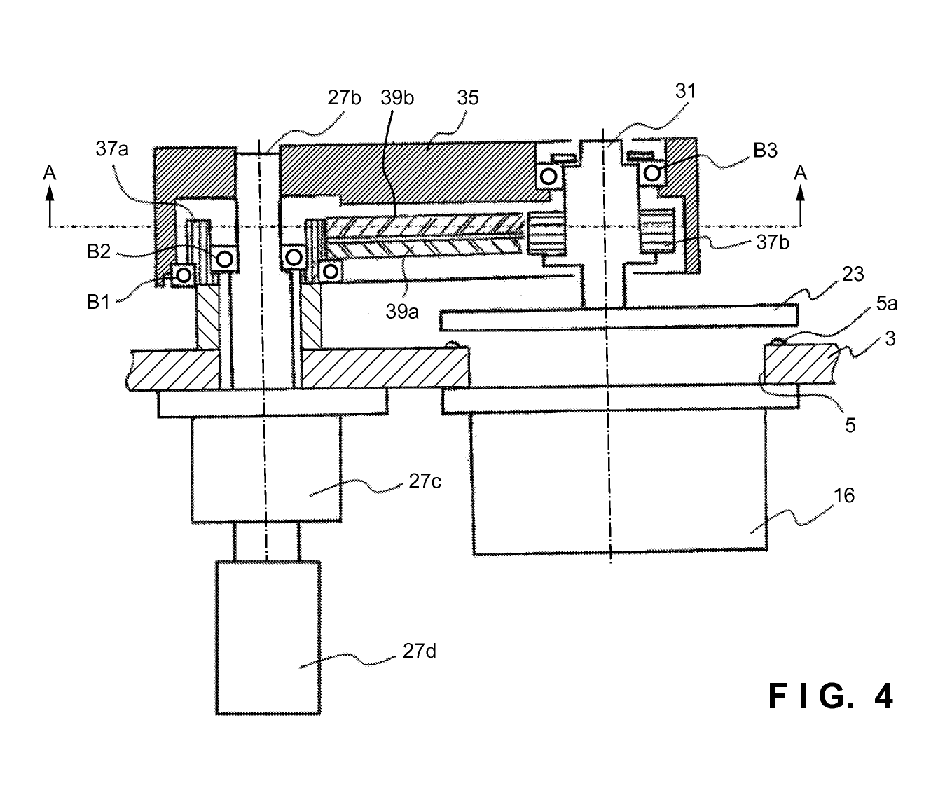

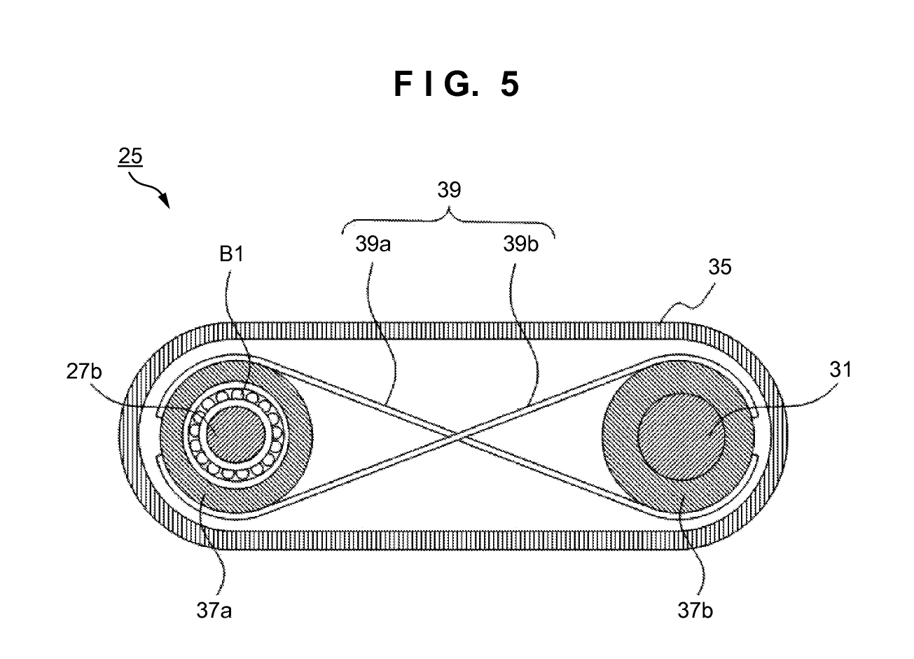

FIG. 4 is a sectional view showing the periphery of the conductance valve. FIG. 5 is a sectional view taken along a line A-A in FIG. 4. The swing arm 25 will be explained in detail with reference to FIGS. 4 and 5. The swing arm 25 includes a case 35, a driving shaft-side pulley 37a (driving-side pulley), a valve body-side pulley 37b, and belts 39, that is, 39a and 39b.

The case 35 is a metal member having a shape surrounding the belts 39 and the pulleys 37, that is, 37a and 37b. The case 35 is fixed to the driving shaft 27b, and operates along with rotation of the driving shaft 27b. The driving shaft-side pulley 37a is a cylindrical member which fixes one end of the belts 39, and is fixed to the driving shaft 27b on the side of the vacuum vessel 11. The driving shaft-side pulley 37a is in contact with the driving shaft 27b via a bearing B1 on the inner circumferential side, and is supported by the case 35 via a bearing B2 on the outer circumferential side. The driving shaft-side pulley 37a is supported by the case 35 so that it can rotate in accordance with rotational driving of the driving shaft 27b. The valve body-side pulley 37b is a cylindrical member which fixes the other end of the belts 39. The valve body-side pulley 37b is fixed to the valve body-side shaft member 31, and supported by the case 35 via a bearing B3 on the outer circumferential side. Rotational driving of the driving shaft 27b is transmitted to the valve body-side pulley 37b via the driving shaft-side pulley 37a and belts 39. The valve body-side pulley 37b is driven by rotational driving of the driving shaft 27b, and the valve body 23 connected via the shaft member 31 moves. The movement of the valve body 23 implements a motion for adjusting the opening degree (opening area) of the opening 5.

The belts 39 are formed from a freely flexible sheet metal, and are members which transmit a rotational force between the driving shaft-side pulley 37a and the valve body-side pulley 37b. The belts 39 are looped between the driving shaft-side pulley 37a and the valve body-side pulley 37b not to slip. In the embodiment, a pair of two belts is used. Note that the driving shaft-side pulley 37a and valve body-side pulley 37b are set to have a predetermined ratio of the outer diameters at which the belt 39 is looped. By adjusting the outer diameter ratio of the driving shaft-side pulley 37a and valve body-side pulley 37b (outer diameter ratio of the pulleys), it is adjusted to rotate the valve body 23 by a predetermined angle when the driving shaft 27b rotates by a predetermined angle. That is, the outer diameter ratio of the pulleys is set to pivot the valve body 23 along with pivoting of the case 35. As a setting example of the outer diameter ratio of the pulleys, it is set to rotate the valve body 23 by 90° every time the swing arm 25 rotates by 45°. The driving shaft-side pulley 37a, valve body-side pulley 37b, and belts 39 form a pivoting transmission portion.

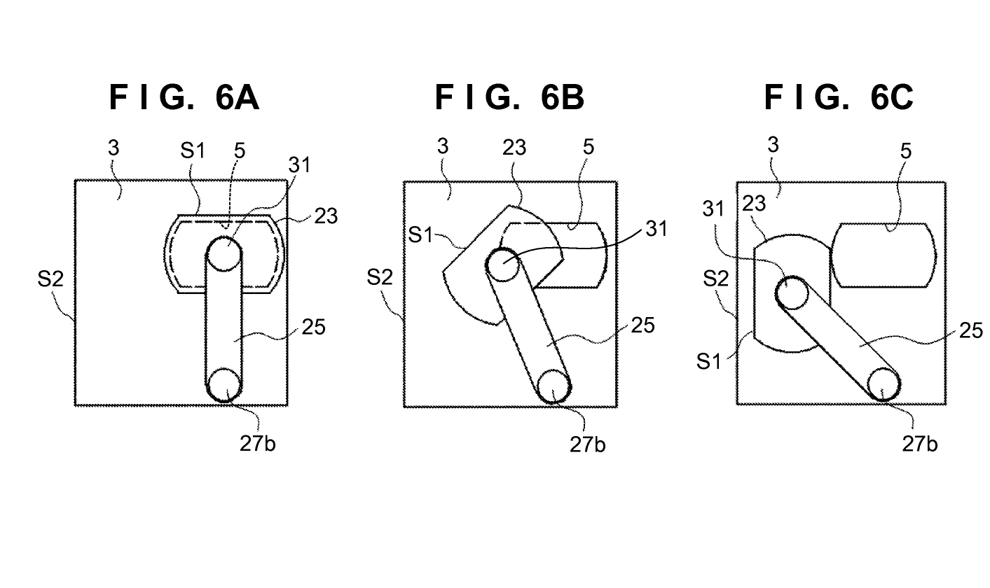

FIGS. 6A to 6C are views for explaining the operation of the conductance valve 21. FIGS. 6A to 6C are schematic views of the conductance valve when viewed from the top when the conductance valve 21 moves from a closed position to an opening position. FIG. 6A shows a state in which the valve body 23 is located at a position (closed position) where it blocks the opening 5 of the vacuum vessel 11. At this time, the conductance valve is at the closed position, and the conductance becomes minimum. FIG. 6B shows the state of the conductance valve 21 when the valve body 23 starts the opening operation. Part of the valve body 23 blocks the opening 5.

FIG. 6C shows a state in which the valve body 23 moves to a position (opening position) where the amount by which the valve body 23 blocks the opening 5 is smallest. At this time, the conductance valve is at the opening position, and the conductance becomes maximum. In the conductance valve 21 according to the embodiment, the swing arm 25 rotates by 45° from an initial position with respect to the vacuum vessel 11, and the valve body rotates by 90°. The valve body 23 is set not to overhang from a side S2 of the bottom 3 at the full opening position because the bottom 3 of the vacuum vessel 11 has a rectangular shape and the valve body 23 has an almost rectangular shape (elliptical shape). Thus, overhanging of the valve body 23 from the bottom 3 can be prevented by conforming the shape of a side S1 forming the valve body 23 to that of the side S2 forming the bottom 3.

When the conductance valve is viewed from the top (see FIGS. 6A and 6B), the swing arm 25 rotates counterclockwise with respect to the vacuum vessel 11, and the valve body 23 rotates counterclockwise with respect to the swing arm 25. That is, when the driving shaft 27b rotates counterclockwise, the swing arm 25 rotates around the driving shaft 27b by the same angle as that of the driving shaft 27b. At this time, the valve body 23 also rotates in accordance with the rotation angle of the driving shaft 27b. The valve body 23 has an almost rectangular shape, the shaft member 31 is fixed to the center position, and thus the moving ranges of the almost rectangular valve body 23 and swing arm 25 can be narrowed. In the embodiment, as shown in FIG. 6C, the conductance valve can be operated so that the valve body 23 does not protrude from the side S2 of the vacuum vessel.

As described above, the ratio of the rotation angle of the driving shaft 27b (swing arm 25) and that of the valve body 23 (rotation ratio of the driving shaft 27b and valve body 23) can be determined by adjusting the outer diameter ratio of the pulleys 37. That is, in the conductance valve according to the embodiment, the valve body 23 is adjusted in accordance with the outer diameter ratio of the rotating pulleys so that the valve body 23 does not protrude from the side S2 of the bottom 3.

Note that the valve body 23 rotates counterclockwise in the embodiment, but may rotate clockwise. The bottom 3 is an arbitrary part of the bottom surface of the vacuum vessel 11. In the embodiment, the conductance valve is arranged so that the longitudinal direction of the valve body 23 and that of the opening 5 cross each other perpendicularly at the opening position (FIG. 6C). This arrangement is advantageous for downsizing and space-saving of the conductance valve.

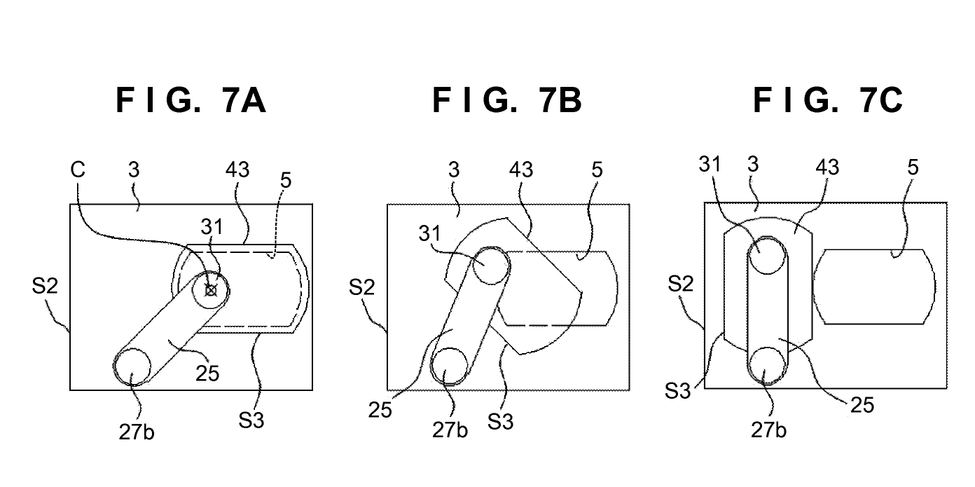

FIGS. 7A to 7C show the second embodiment. The same reference numerals as those in the first embodiment denote the same parts, and a description thereof will not be repeated. The second embodiment is different from the first embodiment in the position of a shaft member 31 of a valve body 43. More specifically, the shaft member 31 is disposed at a position C spaced apart from the center of the valve body 43.

FIG. 7A shows a state in which the valve body 43 is located at a position (closed position) where it blocks an opening 5 of a vacuum vessel 11. FIG. 7B shows the state of a conductance valve when the valve body 43 starts the opening operation.

FIG. 7C shows a state in which the valve body 43 moves to a position (opening position) where the amount by which the valve body 43 blocks the opening 5 is smallest. The shaft member 31 is disposed at a position shifted to one side from the center position of the valve body 43. This can increase, for example, the area by which a swing arm 25 and the valve body 43 overlap each other at the opening position, as shown in FIG. 7C. Since the swing arm 25 and valve body 43 are arranged to overlap each other, the area necessary to arrange the conductance valve with respect to the size of the opening 5 can be decreased, saving the space. In the second embodiment, at the opening position (FIG. 7C), the longitudinal direction of the valve body 43 and that of the swing arm 25 become parallel to each other, and cross that of the opening 5 perpendicularly. This arrangement is advantageous for downsizing and space-saving of the conductance valve.

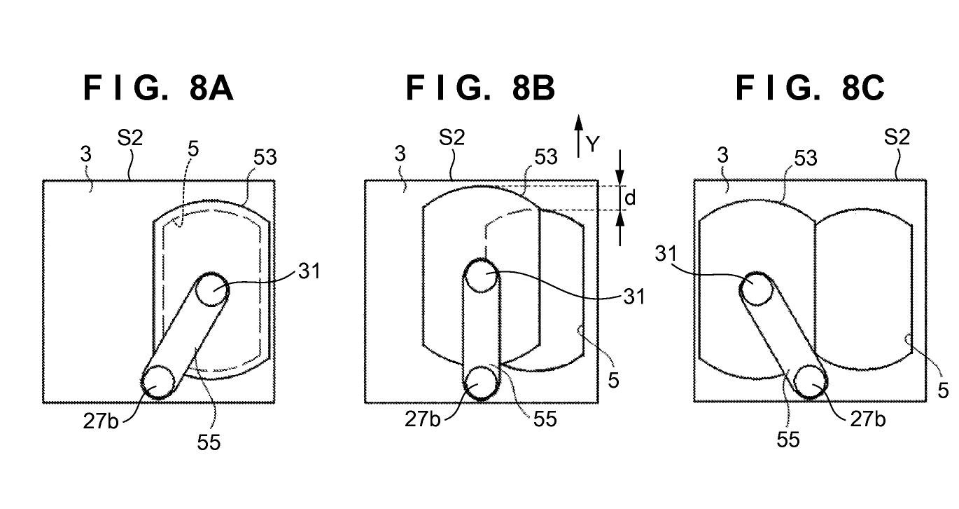

FIGS. 8A to 8C show the third embodiment. The same reference numerals as those in the first embodiment denote the same parts, and a description thereof will not be repeated. The third embodiment is greatly different from the first embodiment in the operation of a valve body 53. More specifically, the valve body 53 does not rotate with respect to a bottom 3, and moves in the lateral direction in accordance with rotation of a swing arm 55. For this reason, the area necessary for a conductance valve with respect to the size of an opening 5 can be decreased. In the third embodiment, a shaft member 31 is disposed at the center position of the valve body 53. FIG. 8A shows a state in which the valve body 53 is located at a position (closed position) where it blocks the opening 5 of a vacuum vessel 11. FIG. 8B shows the state of the conductance valve when the valve body 53 starts the opening operation.

FIG. 8C shows a state in which the valve body 53 moves to a position (opening position) where the amount by which the valve body 53 blocks the opening 5 is smallest. As shown in FIG. 8C, at the opening position of the valve body 53, the area by which the swing arm 55 and opening 5 overlap each other can be decreased. Further, a moving amount d of the valve body 53 in the Y direction (in FIG. 8B) along with rotation of the swing arm 55 can be suppressed. Even when the attaching position of the shaft member 31 is on the side of a driving shaft 27b on the valve body 53, the area by which the swing arm 55 and opening 5 overlap each other can be reduced. Accordingly, the swing arm 55 is hardly influenced by the conductance upon overlapping of the swing arm 55 and opening 5.

In this case, however, the size of the conductance valve becomes large because the moving amount d of the valve body 53 in the Y direction increases. The moving amount in the Y direction in FIG. 8B is a maximum value from the initial position (FIG. 8A) in the locus of a valve body-side pulley 37b in the Y direction in rotation of the swing arm 55. Therefore, the moving amount d of the valve body 53 in the Y direction can be suppressed by increasing the distance between a driving shaft-side pulley 37a and the valve body-side pulley 37b. However, when the distance between the driving shaft-side pulley 37a and the valve body-side pulley 37b increases, the area by which the swing arm 25 and opening 5 overlap increases.

In the third embodiment, the ratio of the driving shaft-side pulley 37a and valve body-side pulley 37b is set so that the longitudinal direction of the valve body 53 moves in parallel with the longitudinal direction of the opening 5. Also, the driving shaft 27b is arranged so that the swing arm 55 becomes parallel to the longitudinal direction of the opening 5 when the valve body 53 is at an intermediate position (FIG. 8B) between the closed position (FIG. 8A) and the opening position (FIG. 8C). This arrangement of the driving shaft 27b is advantageous for downsizing and space-saving of the conductance valve because the valve body 53 can be arranged at symmetrical positions at the closed position (FIG. 8A) and the opening position (FIG. 8C). Further, this arrangement of the driving shaft 27b is advantageous for downsizing and space-saving of the conductance valve because, even when the valve body 53 moves by the moving amount d in the Y direction, as shown in FIG. 8B, it does not protrude from the side S2 of the bottom 3.

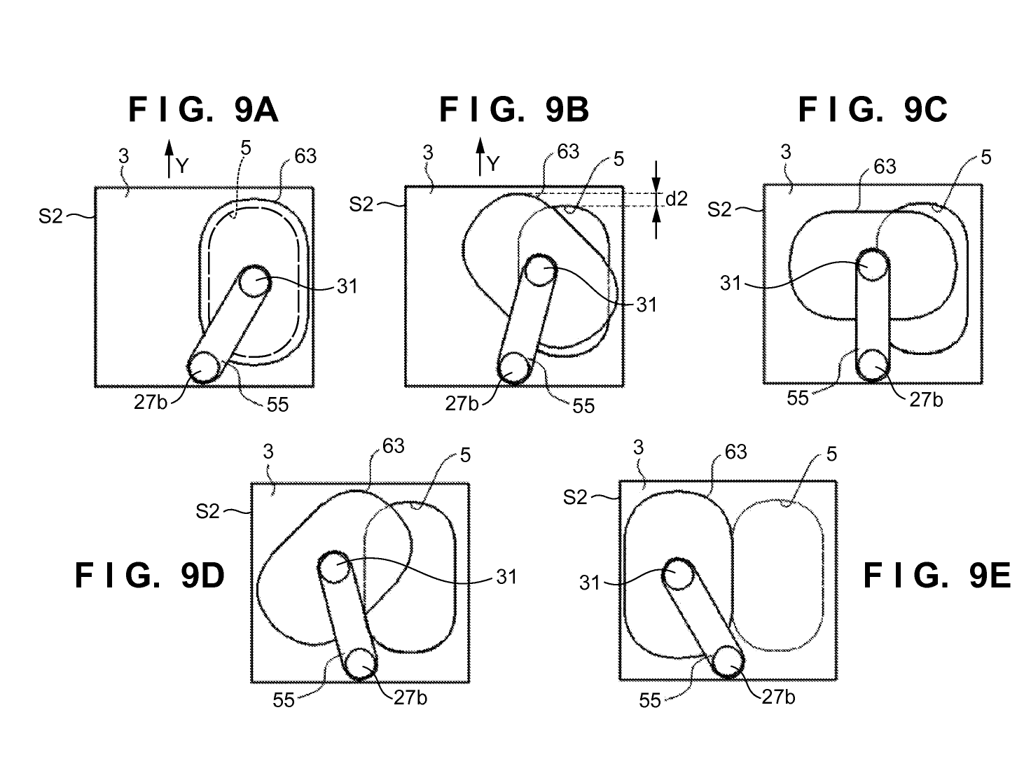

FIGS. 9A to 9E show the fourth embodiment. The same reference numerals as those in the first embodiment denote the same parts, and a description thereof will not be repeated. The fourth embodiment is greatly different from the first embodiment in the operation of a valve body 63.

FIG. 9A shows a state in which the valve body 63 is located at a position (closed position) where it blocks an opening 5 of a vacuum vessel 11. FIG. 9B shows the state of a conductance valve when the valve body 63 starts the opening operation. FIG. 9C shows the intermediate state of the valve body 63 during the opening/closing operation. FIG. 9D shows a state in which the valve body 63 moves from the intermediate state during the opening/closing operation to the opening position of the valve body 63. FIG. 9E shows a state in which the valve body 63 moves to a position (opening position) where the amount by which the valve body 63 blocks the opening 5 is smallest.

More specifically, as shown in FIGS. 9A to 9E, the valve body 63 moves in the lateral direction while rotating in accordance with rotation of a swing arm 55. As shown in FIG. 9C, the valve body 63 faces sideways in the intermediate state of the opening/closing operation. Thus, the length (maximum moving amount d2) by which the valve body 63 overhangs in the Y direction, as shown in FIG. 9B, can be decreased, compared to the arrangement shown in FIGS. 8A to 8C.

A driving shaft 27b in the fourth embodiment is arranged at a position where the swing arm 55 becomes parallel to the longitudinal direction of the opening 5 when the valve body 63 is at the intermediate position (FIG. 9C) between the closed position (FIG. 9A) and the opening position (FIG. 9E). This arrangement of the driving shaft 27b is advantageous for downsizing of the conductance valve because the valve body 63 can be arranged at symmetrical positions at the closed position (FIG. 9A) and the opening position (FIG. 9E). Further, this arrangement of the driving shaft 27b is advantageous for downsizing and space-saving of the conductance valve because, even when the valve body 63 moves by the moving amount d2 in the Y direction, as shown in FIG. 9B, it does not protrude from the side S2 of a bottom 3.

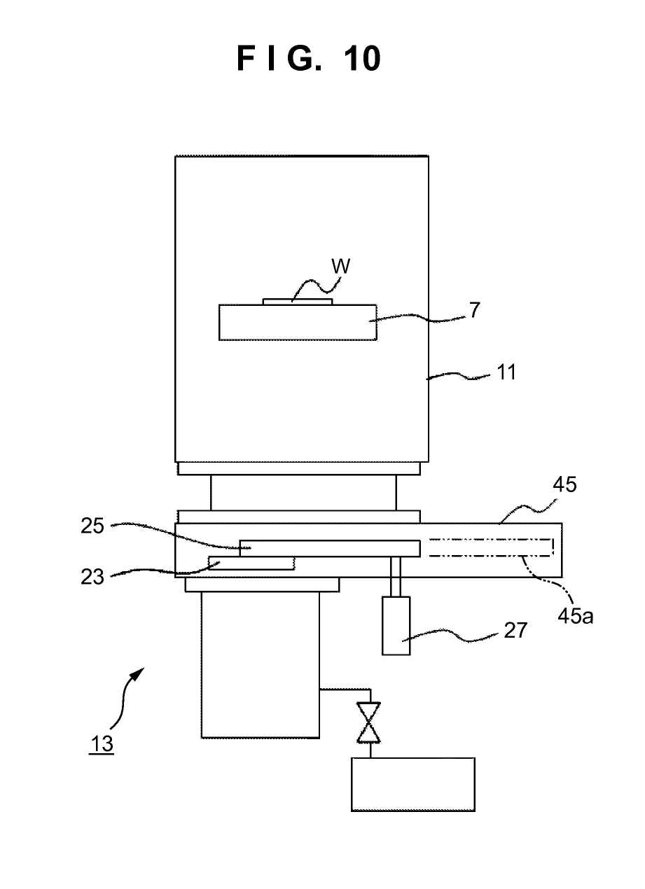

FIG. 10 shows the attaching structure of a conductance valve as the fifth embodiment. The same reference numerals as those in the first embodiment denote the same parts, and a description thereof will not be repeated. As shown in FIG. 1, the conductance valve in the fifth embodiment is configured so that a valve body 23 and swing arm 25 operate in a vacuum vessel 11. In the fifth embodiment, a housing 45 stores the valve body 23, the inside of the housing 45 is made airtight, and then the housing 45 is attached to the vacuum vessel 11.

In this case, the housing 45 is interposed between the vacuum vessel 11 and an exhaust device 13. The housing 45 has an opening communicating with the opening of the vacuum vessel, and the opening degree (conductance) of the opening of the housing 45 is adjusted by the operation of the valve body 23. The member of the housing 45 in which the opening is formed corresponds to a base plate. In FIG. 10, a broken line 45a indicates the position of the swing arm 25 when the swing arm 25 is stored. The conductance valve can be constituted by attaching the valve body 23, the swing arm 25, and a driving portion 27 to the housing 45. Hence, the conductance valve according to the fifth embodiment can be attached to a general vacuum vessel. The fifth embodiment can provide a vacuum processing apparatus with good maintenance workability.

In the above-described embodiments, the driving shaft-side pulley 37a and valve body-side pulley 37b are interlocked with each other by the belts. Instead of the belts, the same operation can be implemented using a gear mechanism. For example, the driving shaft-side pulley 37a and valve body-side pulley 37b may be formed from gears, and these gears may be interlocked with each other via other gears. At this time, the sizes (numbers of teeth) of the gears are preferably determined so that the final rotation ratio of the driving shaft-side gear and valve body-side gear becomes a target ratio.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-285352, filed Dec. 27, 2012, which is hereby incorporated by reference herein in its entirety.

What is claimed is:

1. A conductance valve capable of adjusting a conductance by adjusting an opening degree of an opening formed in part of a vacuum vessel, comprising:
a rectangular valve body;
an arm configured to pivotally couple said valve body; and
a driving portion configured to pivot said arm,
wherein said valve body is pivoted along with pivoting of said arm, and the opening degree of the opening is adjusted in accordance with the pivoting of said valve body.

2. The valve according to claim 1, wherein said arm includes
a case configured to be fixed to a driving shaft of said driving portion, and
a pivoting transmission portion configured to pivot said valve body along with pivoting of said case.

3. The valve according to claim 2, wherein the pivoting transmission portion includes
a driving-side pulley configured to be fixed to part of the vacuum vessel and disposed in the case via a bearing,
a valve body-side pulley configured to be disposed in the case via a bearing and fixed to said valve body, and
a belt configured to transmit a rotational force between the driving-side pulley and the valve body-side pulley.

4. The valve according to claim 3, wherein the valve body-side pulley is coupled at a center position of said valve body.

5. The valve according to claim 3, wherein the valve body-side pulley is coupled at a position spaced apart from a center of said valve body.

6. A vacuum processing apparatus comprising a conductance valve defined in claim 1.
